(19) United States
(12) Patent Application Publication
(10) Pub. No.: US 2019/0200079 A1
(43) Pub. Date: Jun. 27, 2019

(54) Predictive Analysis for Media Encodings

(71) Applicant: Facebook, Inc., Menlo Park, CA (US)

(72) Inventors: Abhishek Mathur, Menlo Park, CA (US); Amit Puntambekar, Fremont, CA (US); Peter Knowles, Palo Alto, CA (US)

(21) Appl. No.: 15/850,597

(22) Filed: Dec. 21, 2017

(51) Int. Cl. H04N 21/466; H04N 21/442; H04N 21/4402; H04N 21/433; H04N 21/45; H04N 21/4788

(52) U.S. Cl. CPC H04N 21/4667; H04N 21/44213; H04N 21/4788; H04N 21/433; H04N 21/4532; H04N 21/4402

(57) ABSTRACT

In one embodiment, a method includes receiving a video; predicting attributes of an audience for the video; identifying one or more encoding formats for the video based on the attributes of the audience; generating encodings for the video in one or more of the encoding formats; and storing the encodings in a data store.

### TECHNICAL FIELD

This disclosure generally relates to determining optimal numbers and types of media encodings to make available for distribution.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

As the sharing of video content becomes more prevalent, with people being able to upload and share videos with one another instantaneously, it is becoming increasingly challenging for video-hosting services to keep up with the processing and storage demands of making the video content available to “audiences” of videos. For the purposes of this disclosure, an audience for a video includes users of client systems who are expected to request access to the video from a computing device that stores the video (e.g., a video that the computing device receives from another client system, a video that is created at the computing device itself). One challenge that arises stems from differences among members of the audience, specifically in the individual contexts under which they request access to a video (e.g., the platform of a client system each member of the audience uses to request access, the network bandwidth available to each member when requesting access). A video may be formatted in any of several encoding formats, and different encoding formats may be optimal for different contexts. As an example and not by way of limitation, a first encoding format may be optimal for an audience member requesting a video on a desktop computer, while a second encoding format may be optimal for an audience member requesting the same video on a mobile device. To enhance the user experience of the audience members, it may be ideal to make the video available, to the audience members, in encoding formats that may be optimal to each of their respective contexts. Ideally, members of the audience would be able to access the video in encoding formats that are optimal to each of their individual contexts. However, there may only be a finite amount of resources available to generate and/or store encodings, and it may not always be possible to keep pace with the number of new videos being uploaded. As a result, there may be times when all possible encodings simply cannot be generated or stored for every video that is being uploaded. This may be especially true on peak days (e.g., New Year's Eve, Valentine's Day, Christmas, weekends), peak times of the day (e.g., peak upload times in countries where videos are frequently uploaded), or other times when video uploads are expected to be high (e.g., when a news-worthy event occurs). One solution is to intelligently determine what encodings should be generated for each video, for any given day or time. In doing so, a computing device involved in generating the encodings may determine a total number of encodings to generate for each video. The computing device may also determine which encodings to generate, selecting one or more encoding formats from a superset of supported encoding formats. These determinations may prioritize videos that are more likely to be popular, generating more encodings for videos that are expected to have a relatively large audience than otherwise. These determinations may also prioritize encodings that are more likely to be popular among an expected audience, favoring the identification, for generation, of encoding formats that are relatively popular over encoding formats that are less popular. Although the disclosure herein focuses on videos, the disclosure contemplates performing methods analogous to the ones described herein to other media content, such as audio, image files, interactive media, or virtual reality content.

In particular embodiments, a computing device may receive a video. The video may be received from a device associated with the computing device itself or from a separate system (e.g., a separate client system). In particular embodiments, the computing device may predict attributes of an audience for the video. In particular embodiments, the computing device may identify one or more encoding formats for the video based on any combination of suitable factors. As an example and not by way of limitation, the one or more encoding formats may be identified based on the attributes of the audience for the video. In particular embodiments, the computing device may generate encodings for the video in one or more of the identified encoding formats. In particular embodiments, the computing device may store the generated encodings in a data store associated with the computing device.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example configuration of systems engaged in uploading, receiving, and distributing media content.

FIG. 2 illustrates an example method for determining and generating an optimal set of encodings for videos.

FIG. 3 illustrates an example network environment associated with a social-networking system.

FIG. 4 illustrates an example social graph.

FIG. 5 illustrates an example computer system.

### DESCRIPTION OF EXAMPLE EMBODIMENTS

As the sharing of video content becomes more prevalent, with people being able to upload and share videos with one another instantaneously, it is becoming increasingly challenging for video-hosting services to keep up with the processing and storage demands of making the video content available to “audiences” of videos. For the purposes of this disclosure, an audience for a video includes users of client systems who are expected to request access to the video from a computing device that stores the video (e.g., a video that the computing device receives from another client system, a video that is created at the computing device itself). One challenge that arises stems from differences among members of the audience, specifically in the individual contexts under which they request access to a video (e.g., the platform of a client system each member of the audience uses to request access, the network bandwidth available to each member when requesting access). A video may be formatted in any of several encoding formats, and different encoding formats may be optimal for different contexts. As an example and not by way of limitation, a first encoding format may be optimal for an audience member requesting a video on a desktop computer, while a second encoding format may be optimal for an audience member requesting the same video on a mobile device. To enhance the user experience of the audience members, it may be ideal to make the video available, to the audience members, in encoding formats that may be optimal to each of their respective contexts. Ideally, members of the audience would be able to access the video in encoding formats that are optimal to each of their individual contexts. However, there may only be a finite amount of resources available to generate and/or store encodings, and it may not always be possible to keep pace with the number of new videos being uploaded. As a result, there may be times when all possible encodings simply cannot be generated or stored for every video that is being uploaded. This may be especially true on peak days (e.g., New Year's Eve, Valentine's Day, Christmas, weekends), peak times of the day (e.g., peak upload times in countries where videos are frequently uploaded), or other times when video uploads are expected to be high (e.g., when a news-worthy event occurs). One solution is to intelligently determine what encodings should be generated for each video, for any given day or time. In doing so, a computing device involved in generating the encodings may determine a total number of encodings to generate for each video. The computing device may also determine which encodings to generate, selecting one or more encoding formats from a superset of supported encoding formats. These determinations may prioritize videos that are more likely to be popular, generating more encodings for videos that are expected to have a relatively large audience than otherwise. These determinations may also prioritize encodings that are more likely to be popular among an expected audience, favoring the identification, for generation, of encoding formats that are relatively popular over encoding formats that are less popular. Although the disclosure herein focuses on videos, the disclosure contemplates performing methods analogous to the ones described herein to other media content, such as audio, image files, interactive media, or virtual reality content.

In particular embodiments, a computing device may receive a video. The video may be received from a device associated with the computing device itself or from a separate system (e.g., a separate client system). In particular embodiments, the computing device may predict attributes of an audience for the video. In particular embodiments, the computing device may identify one or more encoding formats for the video based on any combination of suitable factors. As an example and not by way of limitation, the one or more encoding formats may be identified based on the attributes of the audience for the video. In particular embodiments, the computing device may generate encodings for the video in one or more of the identified encoding formats. In particular embodiments, the computing device may store the generated encodings in a data store associated with the computing device.

In particular embodiments, a computing device may receive a video. In particular embodiments, the video may be a pre-recorded or pre-generated video. Alternatively, the video may be a live-streaming video (e.g., a video that currently being captured or generated). Within this disclosure, both of these types of videos will collectively be referred to by the umbrella term “video.”

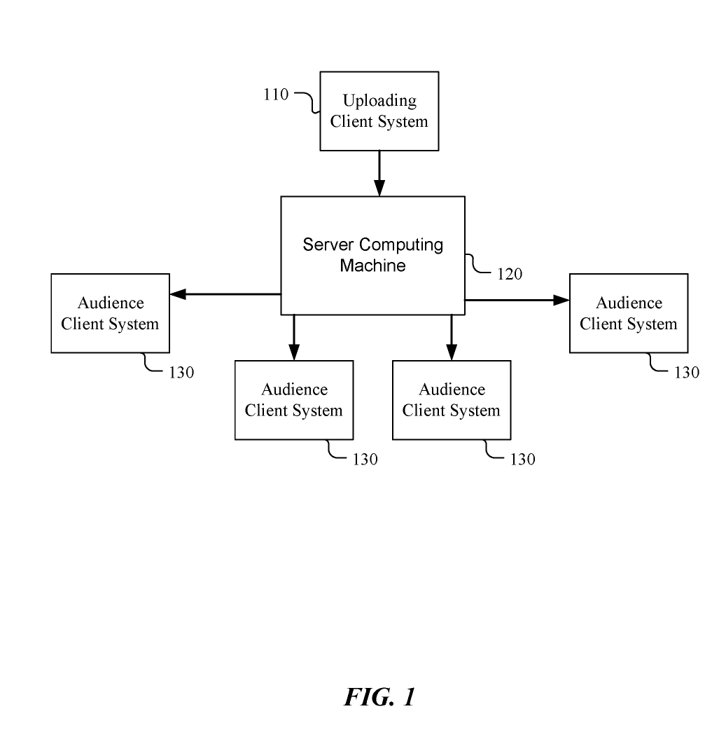

FIG. 1 illustrates an example configuration of systems engaged in uploading, receiving, and distributing media content. In particular embodiments, referencing FIG. 1, the computing device may be an uploading client system 110. As an example and not by way of limitation, the computing device may be a mobile device. In particular embodiments, the computing device may be a client system that receives a video from another client device (e.g., via BlueTooth or any other suitable data-transfer means). In particular embodiments, the computing device may receive a video that originates from an input device associated with the computing device itself. As an example and not by way of limitation, the video may have been captured from a camera of the computing device. In particular embodiments, the video may be received from a storage device associated with the computing device. As an example and not by way of limitation, the video may have been a video stored on a storage drive (e.g., a solid state drive or a hard disk drive) of the computing device, in transient or temporary storage (e.g., in RAM associated with the computing device), or on a removable storage device connected to the computing device. In particular embodiments, the video may be received by the computing device as a processor, graphics card, or other component associated with the computing device generates the video (e.g., a video including computer-generated images), without storing the video.

In particular embodiments, referencing FIG. 1, the computing device may be a server computing machine 120. As an example and not by way of limitation, the computing device may be a server computing machine of a social-networking system 360. In these embodiments, the computing device may receive the video from an uploading client system 110 (e.g., a mobile phone, a laptop computer, a desktop computer). In particular embodiments, the video as received may be in a raw form (e.g., unprocessed video information from an image sensor). Alternatively, the video may be in an initial encoding format (e.g., a compressed format). In particular embodiments, the server computing machine 120 may only accept videos in one of a set of encoding formats deemed suitable for transmission or reception, in which case the uploading client system 110 may be required to generate an initial encoding of the video, and send that encoding. As an example and not by way of limitation, the initial encoding may be a compressed video file that is smaller in size than a raw video file, and may therefore be more suitable for transmission over a network. In particular embodiments, the video in its raw form may not be optimal for transmission to the server computing machine 120. As an example and not by way of limitation, a video may be in a format that is not optimal for transmission, given limits on resources of the server computing machine 120 (e.g., the storage or processing power available to the server computing machine 120, the network bandwidth available to the server computing machine 120) or of the uploading client system 110 (e.g., the storage or processing power available to the server computing machine 110, the network bandwidth available to the uploading client system 110). In this example, the video in its raw form may have a bit rate that is too high for the limited resources of either or both of the uploading client system 110 and the server computing machine 120. In particular embodiments, an encoding that was already generated by the uploading client system 110 may not be one of a set of acceptable encodings supported by the server computing machine 120. In such cases, the computing device may require the uploading client system 110 to generate a suitable initial encoding of the video. Once the uploading client system generates the suitable initial encoding, it may then be permitted to send the encoding to the server computing machine 120.

In particular embodiments, the uploading client system 110 may be a client system of a user of a service provided by the server computing device. As an example and not by way of limitation, the user of the uploading client system 110 may be a user of an online social network associated with the server computing machine (e.g., the social-networking system 360). The received video may be in an initial encoding format that may have been generated at the uploading client system 110 before it is uploaded (e.g., immediately before it is sent to the server computing machine 120, or soon after it is recorded, generated, or captured). The server computing machine 120 may receive the video content from the uploading client system 110 when a user associated with the uploading client system 110 elects to upload a video (e.g., by submitting a pre-recorded video, by initiating a live stream).

In particular embodiments, the computing device may predict attributes of an audience for the video. As used herein, the term “audience” refers to a subset of a user base, and may include a single user or a group of users expected to access the video (e.g., on a client device). Upon accessing the video, a user of the audience may be expected to view or otherwise engage with the video (e.g., by “liking” or otherwise reacting to it, commenting on it, sharing it, saving it). In particular embodiments, the computing device may predict the attributes of the audience based on information associated with the author (e.g., a user who recorded, generated, or otherwise created the video) or uploader of the video (e.g., a non-author user who uploads the video using the uploading client system 110). As an example and not by way of limitation, the computing device may predict the size of an audience based on the number of followers or social connections an author or uploader has (e.g., on an online social network or a video-sharing platform on which the video may be made available), the geo-locations of the followers or social connections of the author or uploader (e.g., followers or social connections from some geo-locations may be more likely than others to access the video), the demographical information of the followers or social connections of the author or uploader (e.g., followers or social connections of some demographics may be more likely than others to access the video), the author or uploader's history of uploading videos and historical data associated with access of those videos (e.g., the number of views, the number of views by unique audience members, the number of times members of the audience reshared the videos, the number of “likes” or other social reactions that were awarded to the videos), the geo-location or demographical information of the author or uploader (e.g., videos of authors or uploaders from certain geo-locations or demographics may be more likely to be accessed than others), or any other such suitable information. As another example and not by way of limitation, the computing device may predict a distribution of client-system platforms that the audience is expected to use in accessing the video based on geo-location information associated with the followers or social connections of the author or uploader of the video (e.g., based on information about the usage of different platforms among users of different demographics and geo-locations), historical data about the different platforms that were used to access previous videos of the author or uploader, or any other suitable information.

In particular embodiments, the attributes of the audience may be based on a topic associated with a video. As an example and not by way of limitation, a video may be associated with one or more topics based on the video's metadata, title, user-created descriptions, user comments or posts associated with the video (e.g., on an online social network or on a video-sharing platform), curated topic associations (e.g., curated by a moderator), or analyses of the video content itself (e.g., based on speech recognition to determine words associated with topics, voice/sound recognition to determine persons or things associated with topics, image recognition to determine images associated with topics). More information on associating videos, images, and/or words with topics may be found in U.S. patent application Ser. No. 13/167,701, filed 23 Jun. 2011; U.S. patent application Ser. No. 14/585,782, filed 30 Dec. 2014; U.S. patent application Ser. No. 14/949,436, filed 23 Nov. 2015; U.S. patent application Ser. No. 14/952,707, filed 1 Dec. 2015; U.S. patent application Ser. No. 15/277,938, filed 27 Sep. 2016; U.S. patent application Ser. No. 13/959,446, filed 5 Aug. 2013; and U.S. patent application Ser. No. 14/983,385, filed 29 Dec. 2015, each of which is incorporated by reference. In these embodiments, the computing device may predict the attributes of an audience for a particular video based on measured attributes of a historical or a current audience of other videos associated with one or more of the same subjects or topics. As an example and not by way of limitation, the computing device may predict the attributes of a video associated with the topic “Dogs” based on attributes that have been or are currently being measured of other videos associated with the topic “Dogs.” In particular embodiments, the attributes of the audience of a particular video may be based on historical or current measured attributes of actual audiences that accessed or are accessing the particular video. In these embodiments, the attributes of the audience may be continuously or semi-continuously updated based on a feedback mechanism that updates the attributes of the audience based on measured attributes of an actual audience of the video.

In particular embodiments, the attributes of the audience may be based on a language associated with a video. As an example and not by way of limitation, the computing device may predict the size of the audience based on the language spoken in the video (e.g., as determined by speech recognition, by categorization of the author or uploader, etc.) and a number of users who are likely to access videos of that language (e.g., as determined by historical data, by profile information identifying a proficiency in the language). For example, all else equal, the computing device may predict a larger audience size for a video that is in a language that is relatively prevalent than for a video that is in a language that is relatively obscure. As another example and not by way of limitation, the computing device may predict the types of platforms or network-bandwidth availabilities of the audience for the video based on the language. For example, for a video in a particular language, the computing device may predict a distribution of platforms among the audience based on the historical usage of different platforms among users who access videos in the particular language.

In particular embodiments, the computing device may identify one or more encoding formats for the video. An encoding format is a content representation format for transmission, storage, and playback of digital video. Each of these encoding formats may specify different containers, bit rates, etc., for the video. As examples and not by way of limitation, common encoding formats for videos include MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEP-2 TS, WAV, Broadcast WAV, LXF, GXF, and VOB. The one or more encoding formats may be identified based on any suitable information about the video, the audience, or processing and storage resources available for generating and storing encodings. This information may be obtained from any suitable source. As an example and not by way of limitation, referencing FIG. 1, when the computing device is the uploading client system 110, the computing device may receive at least some of this information from the server computing machine 120. For example, if the server computing machine is associated with the social-networking system 360, the uploading client system 110 may receive information about the audience from a social graph 400 of the social-networking system 360, and information about storage capacity or processing resources from the social-networking system 360 and also from itself (e.g., the social-networking system 360 may be limited in the number and types of encodings that it can accept or store, the uploading client system 110 may be limited in the number and types of encodings that it generate or store).

In particular embodiments, the computing device may identify one or more encoding formats for the video based on the attributes of the audience. Different encoding formats may be optimal for different contexts. As an example and not by way of limitation, for particular platforms of client systems (e.g., as defined by the hardware and software components of the client systems), certain encoding formats may be more optimal than others. For example, certain encodings may be more optimal for particular operating systems, browsers, applications, processors, device types (e.g., desktop computers, tablet computers, mobile devices, televisions), display devices (e.g., screen size), display settings (e.g., brightness/contrast levels, resolution), or any other suitable hardware and software components. As another example and not by way of limitation, certain encoding formats may be more optimal for certain network-bandwidth availabilities. For example, when there is relatively low network-bandwidth availability (e.g., due to a poor connection, due to the type of connection), a relatively low bit-rate encoding may be more optimal than a relatively high bit-rate encoding. In particular embodiments, the computing device may opt to generate one or more encodings based on the encoding formats that are identified as described herein.

In particular embodiments, the identification of encoding formats may include a determination of the total number of encoding formats that are to be identified. In particular embodiments, this total number of encoding formats may be an optimum number of encoding formats (or may be a number that does not exceed the optimum number of encoding formats), as determined based on, for example, any combination of the factors described herein. The identification of encoding formats may also include a determination of which encoding formats to identify. These two determinations may not be mutually exclusive determinations, and one determination may inform the other. These determinations, while conceptually different, may be based on the same types of factors (e.g., the factors described herein). In particular embodiments, there may be a superset of supported encoding formats (e.g., as pre-determined by the computing device, by a standards-setting body, by developers or administrators, etc.). As an example and not by way of limitation, the computing device may only support eight total encoding formats for videos. In particular embodiments, the computing device may identify a subset of encodings from this superset of supported encodings. This identification of a subset among the superset may be necessary in cases where the computing system may not be able to generate encodings for the video in all the supported formats (e.g., due to constraints in processing and/or storage resources). In particular embodiments, the computing device may identify the encoding formats for the video based on any combination of several factors, such that those described herein. The factors may serve as cues that predict the impact factor of the video (e.g., reflecting number of views the video will have or the levels of user engagement by the audience that are expected for the video) and/or the impact value of each of the encodings (e.g., reflected by the number of audience members that are likely to make use of each respective encoding). In particular embodiments, generally, the computing device may generate more encodings for videos having a relatively high impact factor than otherwise. Similarly, in particular embodiments, for a particular video, the computing device may generally favor the identification of encoding formats having a relatively high impact value than otherwise.

In particular embodiments, the identification of the encoding formats may be based on the size of the audience (i.e., the predicted number of members that make up the audience), and the computing device may determine the total number of encoding formats to identify based on the size of the audience. In general, all else equal, the computing device may prioritize videos that are predicted to have a relatively large audience over videos that are predicted to have a relatively small audience. As an example and not by way of limitation, the computing device may identify more encoding formats for a video with a relatively large audience than for a video with a relatively small audience. In particular embodiments, the determination may also be based on information about the platforms and resources available to the audience (e.g., based on past video accesses of the members of the audience), which may be used to predict the platforms and network bandwidths with which members of the audience will access the video. As an example and not by way of limitation, in the instance where the computing device is a server computing machine associated with the social-networking system 360, the computing device may predict a relatively large number of audience members who might access the video on a particular mobile platform with a particular network-bandwidth range (e.g., based on a history of past accesses by those audience members of the online social network, or a history of past accesses of videos on the online social network or on a third-party site). In this example, the computing device may accordingly favor the identification of one or more encoding formats that are optimal for the particular mobile platform and the particular network-bandwidth range. As another example and not by way of limitation, if the computing device determines that a relatively large group of audience members is likely to have limited resources (e.g., a relatively low bandwidth, as may determined by the respective geo-locations of the audience), the computing device may favor the identification of low-bit-rate encoding formats that may be more easily downloaded by audience members with limited resources. As another example and not by way of limitation, the computing device may determine the total number of encoding formats to identify based on a predicted diversity of the platforms, network bandwidth, or other resources of the audience members. In this example, the computing device may determine that a larger number of encodings are to be identified in the case of an audience with a relatively high diversity in these characteristics than in the case of an audience with a relatively low diversity in these characteristics.

In particular embodiments, the identification of the encoding formats may be based on demographical information about the audience. As an example and not by way of limitation, the computing device may determine which encoding formats to identify based on information about usage frequencies of different types of platforms or about network-bandwidth availabilities among different demographics (e.g., as determined by historical data, surveys, etc.). As another example and not by way of limitation, the computing device may determine the total number of encoding formats to identify based on information about the diversity of platform usage among different demographics. In this example, the computing device may identify more encoding formats for audiences with a relatively large number of people from a demographic that has a relatively high diversity of platform usage. In particular embodiments, the identification of the encoding formats may be based on geo-location information about the audience. As an example and not by way of limitation, the computing device may determine which encoding formats to identify based on information about usage frequencies of different types of platforms or about network-bandwidth availabilities among users in different geo-locations (e.g., as determined by historical data, surveys, etc.). In this example, the computing device may favor the identification of relatively low-bit-rate encoding formats may be increased when a threshold fraction of the members of the audience are determined to have available only a relatively low network bandwidth. In particular embodiments, the identification of the encoding formats may be based on quality-of-service requirements of the audience. As an example and not by way of limitation, when a threshold number of members of the audience are premium subscribers (e.g., paid subscribers), the computing device may favor the identification of an optimal encoding for those members. In this example, the computing device may identify a high-quality encoding for a video when a threshold number of premium subscribers are expected to be part of an audience for the video.

In particular embodiments, the identification of the encoding formats may be based on one or more topics associated with the video and the relative popularity of those topics with respect to other potential topics. The relative popularity of a topic may be determined based on the occurrence of the topic in posts on online social networks (e.g., topics that are “trending”), articles on websites (e.g., blogs, news websites), or any other suitable content source. As an example and not by way of limitation, when the topic “The Simpsons” is trending on an online social network as a result of a large number of posts referencing the TV Show The Simpsons, the computing device may identify a larger number of encoding formats for a video associated with the topic “The Simpsons” than it would if the topic was not trending.

In particular embodiments, the identification of the encoding formats may be based on information associated with a quality of the video as it is received. As an example and not by way of limitation, the computing device may receive a video that is of a relatively low quality (e.g., because it may have been recorded in low quality, because it may have been encoded before transmission at an uploading client system into a low-quality encoding format). In this example, the computing device may opt not to identify a high-quality encoding format (e.g., a high-resolution encoding format) if it determines that generating an encoding in such a format will likely not realize any gains in quality (e.g., since the overall quality may be limited by the information in the received video). As another example and not by way of limitation, if the video that was sent to the computing was in an encoding format with a very high bit rate or file size, the computing device may ensure that it generates at least one low-bitrate or low-file-size encoding to enable a maximum number of audience numbers to easily download and view a the video (including audience members with limited network bandwidth, storage resources, or processing resources). In particular embodiments, the identification of the encoding formats may be based on topics associated with the video. As an example and not by way of limitation, the computing device may identify a relatively large number of encoding formats for a video if it is associated with a topic that is trending on an online social network, on news websites, or online generally. As another example and not by way of limitation, the computing device may favor the identification a high-resolution encoding format for a video that is associated only with the topic “Nature,” but may not similarly favor the identification of the high-resolution encoding format for a video (all else equal) that is associated only with the topic “Taxes.” This may be the case if, for example, users generally have a strong preference for high-resolution videos of nature, but do not have as strong of a preference for high-resolution videos of taxes (e.g., as may be determined by machine-learning methods, surveys, etc.).

In particular embodiments, the identification of the encoding formats may be based on the availability of resources (e.g., processing and/or storage resources) of the computing device or of any other system involved in generating or storing encodings. In particular embodiments, the availability of processing resources may be determined based on predicted numbers of video uploads for a given date or time. As an example and not by way of limitation, the computing device may predict relatively high numbers of video uploads during holidays such as Christmas or New Year's Eve. Such days may be peak periods (globally or at least regionally) for uploads of videos by users. As another example and not by way of limitation, the computing device may predict peak times during the day (e.g., evening time, or any other time during the day in time zones of countries where relatively large numbers of users upload videos). As another example and not by way of limitation, the computing device may predict higher numbers for weekends than for weekdays (or vice versa). In particular embodiments, during peak periods where relatively high numbers of video uploads are predicted for a given time, the computing device may accordingly identify a relatively low total number of encoding formats to generate, to manage the resource demands imposed by the predicted increase in video uploads. By contrast, during relatively idle periods, the SN may generate more encodings for a video than it would at peak times. By basing the number of encoding formats to identify (and ultimately, the number of encodings to generate), the computing device can conserve resources during peak periods where resources are scarce, and effectively prioritize the generation of encodings that are going to be of the highest impact to viewers. In particular embodiments, predictions of numbers of video uploads may be based on historical data associated with time periods. As an example and not by way of limitation, the computing device may base its predictions of the number of video uploads that are expected to occur on an upcoming Valentine's Day based on the number of video uploads that occurred on one or more past Valentine's Days. In particular embodiments, predictions of the number of video uploads may be based on current trends and numbers of video uploads. As an example and not by way of limitation, the computing device may base its prediction on a growing trend in the upload of videos or on a current/recent number of video uploads. In particular embodiments, predictions of the number of video uploads may be based on information other than direct measurement of video uploads. As an example and not by way of limitation, relatively high numbers of video uploads may be predicted when a particularly newsworthy event has happened (e.g., for which users are likely to upload video commentary), as may be determined based on, for example, trending topics on an online social network or content from news websites.

In particular embodiments, as part of the process of identifying encoding formats, the computing device may engage in a ranking process, whereby a set of encoding formats is ranked, relative to each other. As an example and not by way of limitation, the computing device may rank all encoding formats in the superset of supported encoding formats. In particular embodiments, the ranking of the encoding formats may be based on the factors described herein. As an example and not by way of limitation, encoding formats that are optimal for mobile devices may be ranked higher for an audience that has a relatively high distribution of mobile devices than for an audience that has a relatively low distribution of mobile devices. In particular embodiments, the computing device may select, for identification, one or more encoding formats based on their relative ranks. In particular embodiments, the computing device may make use of a threshold rank, selecting only encoding formats ranked equal to or higher than the threshold rank. As an example and not by way of limitation, when the threshold rank is set to three, the computing device may only select the top three encoding formats. In particular embodiments, the threshold rank may be set dynamically, based on the determination of the total number of encoding formats that are to be identified. As an example and not by way of limitation, the computing device may determine that two encoding formats are to be identified, in which case the threshold rank may be set to two. In particular embodiments, the total number of encoding formats may not exceed the optimum number of encoding formats, as determined by, for example, the audience size, the availability of processing and/or storage resources, or any other suitable factors described herein.

In particular embodiments, the computing device may generate encodings for the video in one or more of the identified encoding formats. In particular embodiments, the computing device may identify and/or generate all the identified encoding formats. In particular embodiments, some or all the identification of the encoding formats and the generation of the encodings may be performed by multiple systems. As an example and not by way of limitation, referencing FIG. 1, the uploading client system 110 may identify a single encoding format and generate a single encoding in that encoding format, and may then send the encoding to the server computing machine 120, which may identify other encoding formats and generate corresponding encodings. As another example and not by way of limitation, the uploading client system 110 may identify multiple encoding formats but generate only a single encoding format, and may then send the encoding to the server computing machine 120, which may generate the remaining encoding formats identified by the uploading client system 110 (and may itself identify other encoding formats).

In particular embodiments, the computing device may store the generated encodings in a data store associated with the computing device. As an example and not by way of limitation, when the computing device is a server computing machine (e.g., of the social-networking system 360, some other platform that allows for video sharing), the generated encodings may be stored in a data store associated with the server computing machine (e.g., of the social-networking system 360, or of a video-sharing platform). As another example and not by way of limitation, referencing FIG. 1, when the computing device is an uploading client system 110, one or more of the generated encodings may be stored in a data store of the uploading client system 110 before one or more of the stored encodings are sent to the server computing machine 120, where they may be again stored in a data store associated with the server computing machine 120.

In particular embodiments, the computing device may employ a feedback mechanism to determine whether additional encodings need to be generated for a video. The computing device may continuously or semi-continuously monitor the number of audience client systems accessing the video, and/or the types of platforms of audience client systems accessing the video. As an example and not by way of limitation, the computing device may receive information about an increase in viewership of a video and accordingly generate additional encodings for the video. As another example and not by way of limitation, the computing device may receive information about an unpredicted number of desktop computers requesting a particular encoding and may consequently generate the particular encoding if it had not already been generated. As another example and not by way of limitation, the computing device may monitor the view-time (i.e., the amount of time users spend viewing the video) and/or user engagement levels (e.g., based on data about user engagement such as likes, comments, or reshares) associated with particular encodings and generate additional encodings accordingly. In this example, the computing device may favor the generation of encodings that have high view-time or high user engagement. In this example, the computing device may weight certain types of engagement more highly than other (e.g., weighting the sharing of videos more highly than the liking of videos). In particular embodiments, the computing device may consider information about the client systems that generally access the computing device (e.g., the client systems of users who connect to an online social network associated with the computing device). In these embodiments, the computing device may base its identification of encoding formats by, for example, by ranking and prioritizing encoding formats based on the platforms of the client systems and that generally access the computing device (e.g., prioritizing encoding formats that are optimal for the most prevalent platforms).

In particular embodiments, the audience client systems may communicate among themselves (e.g., with or without the computing device serving as an intermediary) to arrive at a consensus as to what encodings need to be generated next for a video. As an example and not by way of limitation, if a live-stream video only has one low-resolution encoding for a small mobile device screen and a large number of audience client systems (e.g., an absolute majority or a relative majority) are viewing it on a particular type of high-resolution TV screen, the audience client systems may communicate among themselves and arrive at a consensus to request an encoding that is optimal for the particular type of high-resolution TV screen. In particular embodiments, the computing device itself (e.g., the server, the uploading client system) may make this determination, based on input from the audience client systems. As an example and not by way of limitation, the audience client systems may each submit individual requests for encodings, and the computing device may identify an encoding format to be generated (e.g., based on an absolute majority or a relative majority among the requests).

In particular embodiments, an audience client system may submit a request to access a video from the computing device (e.g., a server computing machine) on which the video may be stored. In making this request, the audience client system may specify a set of acceptable encodings (e.g., in order of preference). In particular embodiments, the computing device may query its data stores to determine if it already has any of the acceptable encodings stored therein. If so, the computing device may send to the audience client system one of the acceptable encodings (e.g., the most preferred encoding). If there is no such encoding, the computing device may send a different encoding (e.g., the closest approximation of one of the acceptable encodings) that may not be optimal, but nonetheless operable on the audience client system. Alternatively, the computing device may generate one of the acceptable encodings in response to the request of the audience client system, and may send the encoding after it has been generated. In particular embodiments, even in the case where one of the acceptable encodings exists, the computing device may generate another encoding (e.g., if the existing encoding is not the most preferred encoding). In particular embodiments, the computing device may over time (e.g., periodically) create new encodings to keep up with new technology that demands new encoding formats. As an example and not by way of limitation, as better-resolution displays become more common, additional encodings may be generated for existing videos to accommodate these better-resolution displays. In particular embodiments, the computing device may in some cases start generating a new encoding in preparation for a possible request from an audience client system (i.e., before the audience client system even requests it) based on a prediction that the audience client system is likely to request it. As an example and not by way of limitation, if a user of the audience client system is scrolling an interface of an application toward a video that is about to be auto-played within the interface, the computing device may determine that it is likely the user will want to view the video and may accordingly generate an encoding in anticipation of a request from the respective audience client system if needed. As another example and not by way of limitation, if a user searches for a video on an application associated with the computing device (e.g., an application for an online social network associated with the social-networking system 360), the computing device may, while delivering the search results, generate one or more encodings if necessary.

When authors or uploaders submit videos to be hosted on a computing device such as a server computing machine of an online social network or a video-sharing platform, they may expect the videos to be stored in a data store of the computing device indefinitely (e.g., until the author or uploader subsequently requests the computing device to remove the video from storage). Storing multiple encodings of these videos may be expensive, especially in the long run, as continued storage of encodings creates recurring costs that aggregate over time. In particular embodiments, the computing device may reduce the storage demand by purging, from its associated data stores, at least some encodings of some videos. In particular embodiments, the computing device may select the encodings to purge based on factors similar to those described above. As an example and not by way of limitation, the computing device may favor purging encodings of videos for which the computing device predicts a relatively small audience size in the near future. In particular embodiments, the computing device may select the encodings to purge based on the current impact value of encodings to account for changes in technology. As an example and not by way of limitation, the computing device may purge encodings for platforms that are no longer in common use. In particular embodiments, the computing device may select the encodings to purge based on the length of time since the upload of the video, the length of time since the last access of the video by an audience member or by a threshold number of audience members. As an example and not by way of limitation, if a video was uploaded five years ago, and if it has been four years since more than ten audience members (or any other threshold number of audience members) have accessed the video, the computing device may purge one or more encodings of the video. In particular embodiments, the computing device may select the encodings to purge based on a current relevance of the video. As an example and not by way of limitation, a video about fixing an issue with a car may be more relevant than a video about fixing an issue with a horse-drawn carriage (e.g., because the former may be more relevant or useful to the current general public than the latter). In this example, the computing device may be more likely to purge an encoding of the latter than the former.

In particular embodiments, the computing device may optionally purge and regenerate encodings for videos as necessary. As an example and not by way of limitation, the computing device may cyclically purge and regenerate encodings for videos as they become relevant (e.g., as determined by topics associated with the videos). For example, the computing device may purge one or more encodings for a video about preparing tax forms every year after the tax forms have become due and may regenerate one or more of those encodings when people are expected to be preparing the tax forms again. As another example and not by way of limitation, the computing device may regenerate encodings for an old video that had previously been purged when the old video starts becoming popular again (e.g., as may be determined by an upward trend in access of the video and/or user engagement with the video).

In particular embodiments, to further handle processing and storage demands, a server computing device may crowdsource at least some of the processing required for generating encodings. In particular embodiments, a server computing machine receiving a video from an uploading client system may specify that the uploading client system generate a particular initial encoding. In these embodiments, the uploading client system may generate and send only the specified particular initial encoding. In particular embodiments, the server computing system may request that an uploading client system generate multiple encodings to send to the server computing system. As an example and not by way of limitation, the server computing device may require that the uploading client system generate two encodings—one for a particular type of mobile device and one for a particular type of desktop computing device. In particular embodiments, the server computing device may also request that one or more audience client systems generate one or more encodings. As an example and not by way of limitation, the server computing device may require that a first audience client system generate a first encoding, a second audience client system generate a second encoding, etc. In particular embodiments, the server computing device may distribute processing tasks for a single encoding across multiple audience client systems connected to the server computing device, such that their combined processing generates the single encoding (e.g., so that any one audience client system is not overly burdened).

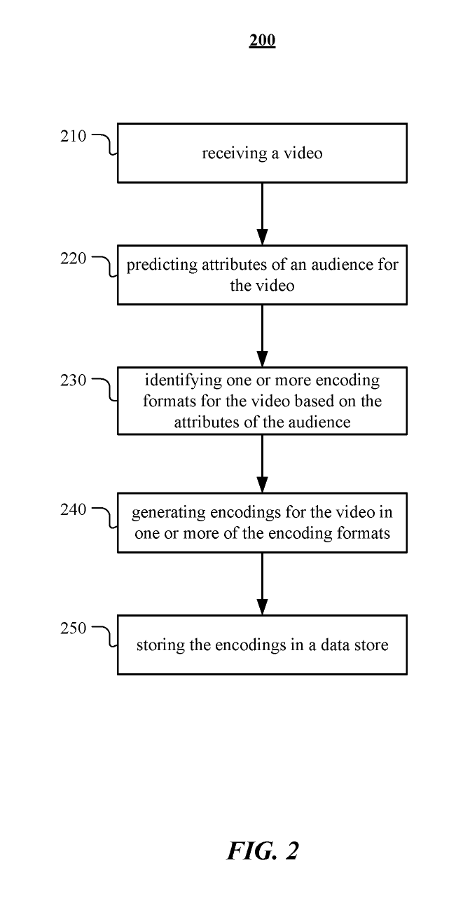

FIG. 2 illustrates an example method 200 for determining and generating an optimal set of encodings for videos. The method may begin at step 210, where a computing device may receive a video. At step 220, the computing device may predict attributes of an audience for the video. At step 230, the computing device may identify one or more encoding formats for the video based on the attributes of the audience. At step 240, the computing device may generate encodings for the video in one or more of the encoding formats. At step 250, the computing device may store the encodings in a data store associated with the computing device. Particular embodiments may repeat one or more steps of the method of FIG. 2, where appropriate. Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates an example method for determining and generating an optimal set of encodings for videos including the particular steps of the method of FIG. 2, this disclosure contemplates any suitable method for determining and generating an optimal set of encodings for videos including any suitable steps, which may include all, some, or none of the steps of the method of FIG. 2, where appropriate. Furthermore, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2.

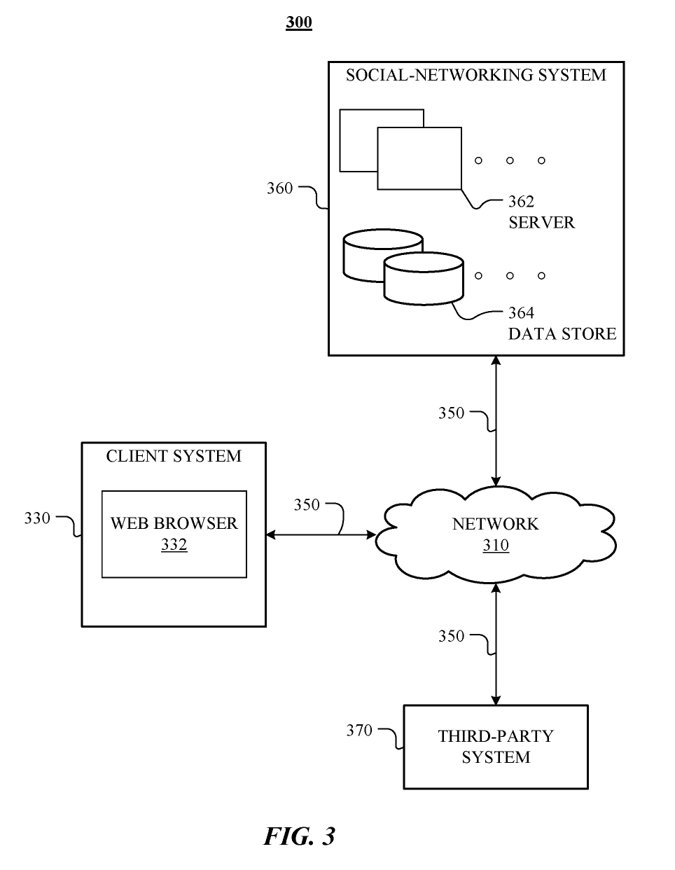

FIG. 3 illustrates an example network environment 300 associated with a social-networking system. Network environment 300 includes a client system 330, a social-networking system 360, and a third-party system 370 connected to each other by a network 310. Although FIG. 3 illustrates a particular arrangement of client system 330, social-networking system 360, third-party system 370, and network 310, this disclosure contemplates any suitable arrangement of client system 330, social-networking system 360, third-party system 370, and network 310. As an example and not by way of limitation, two or more of client system 330, social-networking system 360, and third-party system 370 may be connected to each other directly, bypassing network 310. As another example, two or more of client system 330, social-networking system 360, and third-party system 370 may be physically or logically co-located with each other in whole or in part. Moreover, although FIG. 3 illustrates a particular number of client systems 330, social-networking systems 360, third-party systems 370, and networks 310, this disclosure contemplates any suitable number of client systems 330, social-networking systems 360, third-party systems 370, and networks 310. As an example and not by way of limitation, network environment 300 may include multiple client system 330, social-networking systems 360, third-party systems 370, and networks 310.

This disclosure contemplates any suitable network 310. As an example and not by way of limitation, one or more portions of network 310 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 310 may include one or more networks 310.

Links 350 may connect client system 330, social-networking system 360, and third-party system 370 to communication network 310 or to each other. This disclosure contemplates any suitable links 350. In particular embodiments, one or more links 350 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 350 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 350, or a combination of two or more such links 350. Links 350 need not necessarily be the same throughout network environment 300. One or more first links 350 may differ in one or more respects from one or more second links 350.

In particular embodiments, client system 330 may be an electronic device including hardware, software, or embedded logic components or a combination of two or more such components and capable of carrying out the appropriate functionalities implemented or supported by client system 330. As an example and not by way of limitation, a client system 330 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 330. A client system 330 may enable a network user at client system 330 to access network 310. A client system 330 may enable its user to communicate with other users at other client systems 330.

In particular embodiments, client system 330 may include a web browser 332, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 330 may enter a Uniform Resource Locator (URL) or other address directing the web browser 332 to a particular server (such as server 362, or a server associated with a third-party system 370), and the web browser 332 may generate a Hyper Text Transfer Protocol (HTTP) request and communicate the HTTP request to server. The server may accept the HTTP request and communicate to client system 330 one or more Hyper Text Markup Language (HTML) files responsive to the HTTP request. Client system 330 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 360 may be a network-addressable computing system that can host an online social network. Social-networking system 360 may generate, store, receive, and send social-networking data, such as, for example, user-profile data, concept-profile data, social-graph information, or other suitable data related to the online social network. Social-networking system 360 may be accessed by the other components of network environment 300 either directly or via network 310. As an example and not by way of limitation, client system 330 may access social-networking system 360 using a web browser 332, or a native application associated with social-networking system 360 (e.g., a mobile social-networking application, a messaging application, another suitable application, or any combination thereof) either directly or via network 310. In particular embodiments, social-networking system 360 may include one or more servers 362. Each server 362 may be a unitary server or a distributed server spanning multiple computers or multiple datacenters. Servers 362 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 362 may include hardware, software, or embedded logic components or a combination of two or more such components for carrying out the appropriate functionalities implemented or supported by server 362. In particular embodiments, social-networking system 360 may include one or more data stores 364. Data stores 364 may be used to store various types of information. In particular embodiments, the information stored in data stores 364 may be organized according to specific data structures. In particular embodiments, each data store 364 may be a relational, columnar, correlation, or other suitable database. Although this disclosure describes or illustrates particular types of databases, this disclosure contemplates any suitable types of databases. Particular embodiments may provide interfaces that enable a client system 330, a social-networking system 360, or a third-party system 370 to manage, retrieve, modify, add, or delete, the information stored in data store 364.

In particular embodiments, social-networking system 360 may store one or more social graphs in one or more data stores 364. In particular embodiments, a social graph may include multiple nodes—which may include multiple user nodes (each corresponding to a particular user) or multiple concept nodes (each corresponding to a particular concept)—and multiple edges connecting the nodes. Social-networking system 360 may provide users of the online social network the ability to communicate and interact with other users. In particular embodiments, users may join the online social network via social-networking system 360 and then add connections (e.g., relationships) to a number of other users of social-networking system 360 to whom they want to be connected. Herein, the term “friend” may refer to any other user of social-networking system 360 with whom a user has formed a connection, association, or relationship via social-networking system 360.

In particular embodiments, social-networking system 360 may provide users with the ability to take actions on various types of items or objects, supported by social-networking system 360. As an example and not by way of limitation, the items and objects may include groups or social networks to which users of social-networking system 360 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 360 or by an external system of third-party system 370, which is separate from social-networking system 360 and coupled to social-networking system 360 via a network 310.

In particular embodiments, social-networking system 360 may be capable of linking a variety of entities. As an example and not by way of limitation, social-networking system 360 may enable users to interact with each other as well as receive content from third-party systems 370 or other entities, or to allow users to interact with these entities through an application programming interfaces (API) or other communication channels.

In particular embodiments, a third-party system 370 may include one or more types of servers, one or more data stores, one or more interfaces, including but not limited to APIs, one or more web services, one or more content sources, one or more networks, or any other suitable components, e.g., that servers may communicate with. A third-party system 370 may be operated by a different entity from an entity operating social-networking system 360. In particular embodiments, however, social-networking system 360 and third-party systems 370 may operate in conjunction with each other to provide social-networking services to users of social-networking system 360 or third-party systems 370. In this sense, social-networking system 360 may provide a platform, or backbone, which other systems, such as third-party systems 370, may use to provide social-networking services and functionality to users across the Internet.

In particular embodiments, a third-party system 370 may include a third-party content object provider. A third-party content object provider may include one or more sources of content objects, which may be communicated to a client system 330. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 360 also includes user-generated content objects, which may enhance a user's interactions with social-networking system 360. User-generated content may include anything a user can add, upload, send, or “post” to social-networking system 360. As an example and not by way of limitation, a user communicates posts to social-networking system 360 from a client system 330. Posts may include data such as status updates or other textual data, location information, photos, videos, links, music or other similar data or media. Content may also be added to social-networking system 360 by a third-party through a “communication channel,” such as a newsfeed or stream.

In particular embodiments, social-networking system 360 may include a variety of servers, sub-systems, programs, modules, logs, and data stores. In particular embodiments, social-networking system 360 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 360 may also include suitable components such as network interfaces, security mechanisms, load balancers, failover servers, management-and-network-operations consoles, other suitable components, or any suitable combination thereof. In particular embodiments, social-networking system 360 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 360 to one or more client systems 330 or one or more third-party system 370 via network 310. The web server may include a mail server or other messaging functionality for receiving and routing messages between social-networking system 360 and one or more client systems 330. An API-request server may allow a third-party system 370 to access information from social-networking system 360 by calling one or more APIs. An action logger may be used to receive communications from a web server about a user's actions on or off social-networking system 360. In conjunction with the action log, a third-party-content-object log may be maintained of user exposures to third-party-content objects. A notification controller may provide information regarding content objects to a client system 330. Information may be pushed to a client system 330 as notifications, or information may be pulled from client system 330 responsive to a request received from client system 330. Authorization servers may be used to enforce one or more privacy settings of the users of social-networking system 360. A privacy setting of a user determines how particular information associated with a user can be shared. The authorization server may allow users to opt in to or opt out of having their actions logged by social-networking system 360 or shared with other systems (e.g., third-party system 370), such as, for example, by setting appropriate privacy settings. Third-party-content-object stores may be used to store content objects received from third parties, such as a third-party system 370. Location stores may be used for storing location information received from client systems 330 associated with users. Advertisement-pricing modules may combine social information, the current time, location information, or other suitable information to provide relevant advertisements, in the form of notifications, to a user.

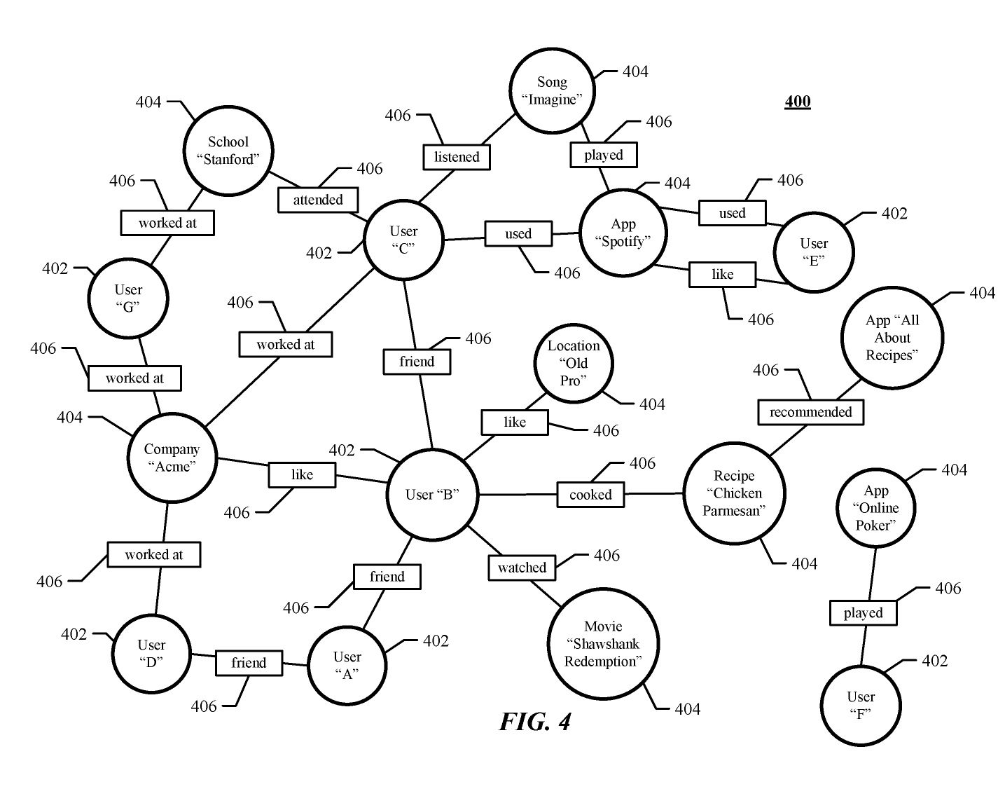

FIG. 4 illustrates example social graph 400. In particular embodiments, social-networking system 360 may store one or more social graphs 400 in one or more data stores. In particular embodiments, social graph 400 may include multiple nodes—which may include multiple user nodes 402 or multiple concept nodes 404—and multiple edges 406 connecting the nodes. Example social graph 400 illustrated in FIG. 4 is shown, for didactic purposes, in a two-dimensional visual map representation. In particular embodiments, a social-networking system 360, client system 330, or third-party system 370 may access social graph 400 and related social-graph information for suitable applications. The nodes and edges of social graph 400 may be stored as data objects, for example, in a data store (such as a social-graph database). Such a data store may include one or more searchable or queryable indexes of nodes or edges of social graph 400.

In particular embodiments, a user node 402 may correspond to a user of social-networking system 360. As an example and not by way of limitation, a user may be an individual (human user), an entity (e.g., an enterprise, business, or third-party application), or a group (e.g., of individuals or entities) that interacts or communicates with or over social-networking system 360. In particular embodiments, when a user registers for an account with social-networking system 360, social-networking system 360 may create a user node 402 corresponding to the user, and store the user node 402 in one or more data stores. Users and user nodes 402 described herein may, where appropriate, refer to registered users and user nodes 402 associated with registered users. In addition or as an alternative, users and user nodes 402 described herein may, where appropriate, refer to users that have not registered with social-networking system 360. In particular embodiments, a user node 402 may be associated with information provided by a user or information gathered by various systems, including social-networking system 360. As an example and not by way of limitation, a user may provide his or her name, profile picture, contact information, birth date, sex, marital status, family status, employment, education background, preferences, interests, or other demographic information. In particular embodiments, a user node 402 may be associated with one or more data objects corresponding to information associated with a user. In particular embodiments, a user node 402 may correspond to one or more webpages.

In particular embodiments, a concept node 404 may correspond to a concept. As an example and not by way of limitation, a concept may correspond to a place (such as, for example, a movie theater, restaurant, landmark, or city); a website (such as, for example, a website associated with social-network system 360 or a third-party website associated with a web-application server); an entity (such as, for example, a person, business, group, sports team, or celebrity); a resource (such as, for example, an audio file, video file, digital photo, text file, structured document, or application) which may be located within social-networking system 360 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 404 may be associated with information of a concept provided by a user or information gathered by various systems, including social-networking system 360. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 404 may be associated with one or more data objects corresponding to information associated with concept node 404. In particular embodiments, a concept node 404 may correspond to one or more webpages.

In particular embodiments, a node in social graph 400 may represent or be represented by a webpage (which may be referred to as a “profile page”). Profile pages may be hosted by or accessible to social-networking system 360. Profile pages may also be hosted on third-party websites associated with a third-party system 370. As an example and not by way of limitation, a profile page corresponding to a particular external webpage may be the particular external webpage and the profile page may correspond to a particular concept node 404. Profile pages may be viewable by all or a selected subset of other users. As an example and not by way of limitation, a user node 402 may have a corresponding user-profile page in which the corresponding user may add content, make declarations, or otherwise express himself or herself. As another example and not by way of limitation, a concept node 404 may have a corresponding concept-profile page in which one or more users may add content, make declarations, or express themselves, particularly in relation to the concept corresponding to concept node 404.

In particular embodiments, a concept node 404 may represent a third-party webpage or resource hosted by a third-party system 370. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 330 to send to social-networking system 360 a message indicating the user's action. In response to the message, social-networking system 360 may create an edge (e.g., a check-in-type edge) between a user node 402 corresponding to the user and a concept node 404 corresponding to the third-party webpage or resource and store edge 406 in one or more data stores.

In particular embodiments, a pair of nodes in social graph 400 may be connected to each other by one or more edges 406. An edge 406 connecting a pair of nodes may represent a relationship between the pair of nodes. In particular embodiments, an edge 406 may include or represent one or more data objects or attributes corresponding to the relationship between a pair of nodes. As an example and not by way of limitation, a first user may indicate that a second user is a “friend” of the first user. In response to this indication, social-networking system 360 may send a “friend request” to the second user. If the second user confirms the “friend request,” social-networking system 360 may create an edge 406 connecting the first user's user node 402 to the second user's user node 402 in social graph 400 and store edge 406 as social-graph information in one or more of data stores 364. In the example of FIG. 4, social graph 400 includes an edge 406 indicating a friend relation between user nodes 402 of user “A” and user “B” and an edge indicating a friend relation between user nodes 402 of user “C” and user “B.” Although this disclosure describes or illustrates particular edges 406 with particular attributes connecting particular user nodes 402, this disclosure contemplates any suitable edges 406 with any suitable attributes connecting user nodes 402. As an example and not by way of limitation, an edge 406 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 400 by one or more edges 406.

In particular embodiments, an edge 406 between a user node 402 and a concept node 404 may represent a particular action or activity performed by a user associated with user node 402 toward a concept associated with a concept node 404. As an example and not by way of limitation, as illustrated in FIG. 4, a user may “like,” “attended,” “played,” “listened,” “cooked,” “worked at,” or “watched” a concept, each of which may correspond to an edge type or subtype. A concept-profile page corresponding to a concept node 404 may include, for example, a selectable “check in” icon (such as, for example, a clickable “check in” icon) or a selectable “add to favorites” icon. Similarly, after a user clicks these icons, social-networking system 360 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 360 may create a “listened” edge 406 and a “used” edge (as illustrated in FIG. 4) between user nodes 402 corresponding to the user and concept nodes 404 corresponding to the song and application to indicate that the user listened to the song and used the application. Moreover, social-networking system 360 may create a “played” edge 406 (as illustrated in FIG. 4) between concept nodes 404 corresponding to the song and the application to indicate that the particular song was played by the particular application. In this case, “played” edge 406 corresponds to an action performed by an external application (SPOTIFY) on an external audio file (the song “Imagine”). Although this disclosure describes particular edges 406 with particular attributes connecting user nodes 402 and concept nodes 404, this disclosure contemplates any suitable edges 406 with any suitable attributes connecting user nodes 402 and concept nodes 404. Moreover, although this disclosure describes edges between a user node 402 and a concept node 404 representing a single relationship, this disclosure contemplates edges between a user node 402 and a concept node 404 representing one or more relationships. As an example and not by way of limitation, an edge 406 may represent both that a user likes and has used at a particular concept. Alternatively, another edge 406 may represent each type of relationship (or multiples of a single relationship) between a user node 402 and a concept node 404 (as illustrated in FIG. 4 between user node 402 for user “E” and concept node 404 for “SPOTIFY”).

In particular embodiments, social-networking system 360 may create an edge 406 between a user node 402 and a concept node 404 in social graph 400. As an example and not by way of limitation, a user viewing a concept-profile page (such as, for example, by using a web browser or a special-purpose application hosted by the user's client system 330) may indicate that he or she likes the concept represented by the concept node 404 by clicking or selecting a “Like” icon, which may cause the user's client system 330 to send to social-networking system 360 a message indicating the user's liking of the concept associated with the concept-profile page. In response to the message, social-networking system 360 may create an edge 406 between user node 402 associated with the user and concept node 404, as illustrated by “like” edge 406 between the user and concept node 404. In particular embodiments, social-networking system 360 may store an edge 406 in one or more data stores. In particular embodiments, an edge 406 may be automatically formed by social-networking system 360 in response to a particular user action. As an example and not by way of limitation, if a first user uploads a picture, watches a movie, or listens to a song, an edge 406 may be formed between user node 402 corresponding to the first user and concept nodes 404 corresponding to those concepts. Although this disclosure describes forming particular edges 406 in particular manners, this disclosure contemplates forming any suitable edges 406 in any suitable manner.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 404 corresponding to a particular photo may have a privacy setting specifying that the photo may only be accessed by users tagged in the photo and their friends. In particular embodiments, privacy settings may allow users to opt in or opt out of having their actions logged by social-networking system 360 or shared with other systems (e.g., third-party system 370). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 370, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 362 may be authorization/privacy servers for enforcing privacy settings. In response to a request from a user (or other entity) for a particular object stored in a data store 364, social-networking system 360 may send a request to the data store 364 for the object. The request may identify the user associated with the request and may only be sent to the user (or a client system 330 of the user) if the authorization server determines that the user is authorized to access the object based on the privacy settings associated with the object. If the requesting user is not authorized to access the object, the authorization server may prevent the requested object from being retrieved from the data store 364, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

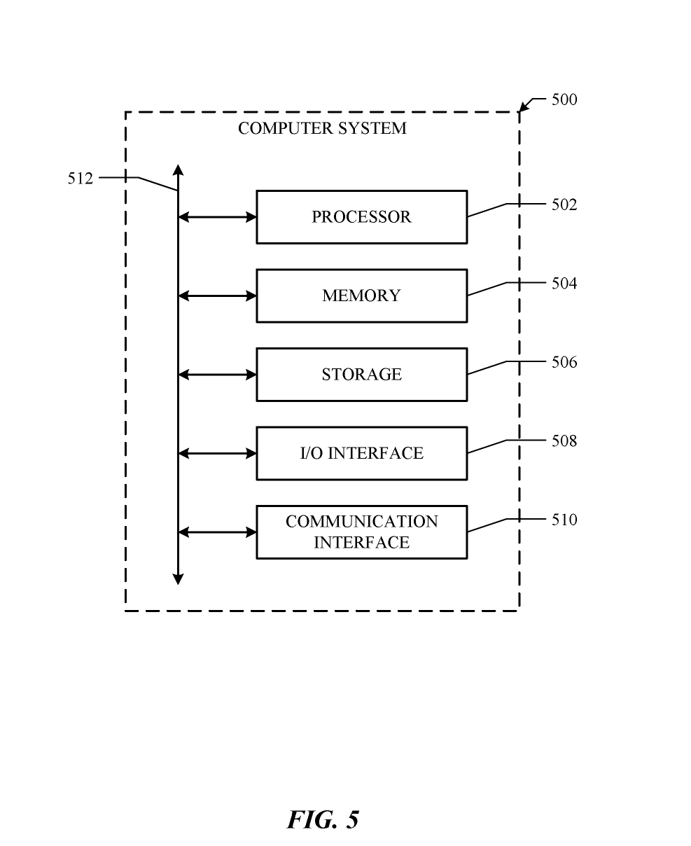

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
receiving, by a computing device, a video;
predicting, by the computing device, attributes of an audience for the video, wherein the attributes of the audience are predicted based on information associated with an author or an uploader of the video;
identifying, by the computing device, one or more encoding formats for the video based on the attributes of the audience;
generating, by the computing device, encodings for the video in one or more of the encoding formats; and
storing, by the computing device, the encodings in a data store associated with the computing device.

2. The method of claim 1, wherein the attributes of the audience comprise information about types of platforms that the audience is expected to use in accessing the video, and wherein the one or more encoding formats are identified based on the types of platforms.

3. The method of claim 1, wherein the attributes of the audience comprise demographical information about the audience, and wherein the one or more encoding formats are identified based on information about usage frequencies of different types of platforms among different demographics.

4. The method of claim 1, wherein the attributes of the audience comprise geo-location information about the audience, and wherein the one or more encoding formats are identified based on information about usage frequencies of different types of platforms among users in different geo-locations.

5. The method of claim 1, wherein the attributes of the audience comprise information about availabilities of network bandwidth to members of the audience, and wherein the one or more encoding formats are identified based on the availabilities of network bandwidth, wherein the likelihood of identifying relatively low-bit-rate encoding formats is increased when a threshold fraction of the members of the audience are determined to have available only a relatively low network bandwidth.

6. The method of claim 1, wherein the attributes of the audience comprise information about a size of the audience.

7. The method of claim 1, wherein the attributes of the audience comprises information about quality-of-service requirements of the audience.

8. The method of claim 1, wherein the identifying of the one or more encoding formats comprises:
ranking a set of supported encoding formats; and
selecting, from the set of supported encoding formats, one or more encoding formats to be identified based on relative ranking values of the supported encoding formats.

9. The method of claim 8, wherein a total number of selected encoding formats does not exceed an optimum number of encoding formats, the optimum number of encoding formats being determined based on the attributes of the audience.

10. The method of claim 9, wherein the attributes of the audience comprise information about types of platforms that the audience is expected to use in accessing the video, and wherein the optimum number is determined based on an expected level of diversity in the types of platforms the audience is expected to use and expected numbers of each of the types of platforms the audience is expected to use.

11. The method of claim 9, wherein the optimum number is further based on processing resources available to the computing device.

12. The method of claim 1, wherein the encoding formats are further identified based on information associated with an author of the video.

13. The method of claim 1, wherein the encoding formats are further identified based on information associated with a quality of the video.

14. The method of claim 1, wherein the encoding formats are further identified based on one or more topics associated with the video.

15. The method of claim 1, further comprising:
predicting a size of an audience for a particular video;
determining that the size of the audience is below a threshold size; and
purging a particular stored encoding for the particular video by removing the particular stored encoding from the data store.

16. The method of claim 15, further comprising:
re-predicting the size of the audience for the particular video;
determining that the re-predicted size of the audience is above a threshold size; and
re-generating the particular stored encoding for the video.

17. The method of claim 1, further comprising:
monitoring a number of audience client systems accessing the video;
identifying, based on the monitoring of the number of audience client systems accessing the video, an additional encoding format for the video; and
generating an encoding for the video in the additional encoding format.

18. The method of claim 1, further comprising:
monitoring types of platforms of a plurality of audience client systems accessing the video;
identifying, based on the monitoring of the types of platforms accessing the video, an additional encoding format for the video; and
generating an encoding for the video in the additional encoding format.

19. One or more computer-readable non-transitory storage media embodying software that is operable when executed to:
receive a video;
predict attributes of an audience for the video, wherein the attributes of the audience are predicted based on information associated with an author or an uploader of the video;
identify one or more encoding formats for the video based on the attributes of the audience;
generate encodings for the video in one or more of the encoding formats; and
store the encodings in a data store.

20. A system comprising: one or more processors; and a memory coupled to the processors comprising instructions executable by the processors, the processors being operable when executing the instructions to:
receive a video;
predict attributes of an audience for the video, wherein the attributes of the audience are predicted based on information associated with an author or an uploader of the video;
identify one or more encoding formats for the video based on the attributes of the audience;
generate encodings for the video in one or more of the encoding formats; and
store the encodings in a data store.
